(19) United States
(12) Patent Application Publication
(10) Pub. No.: US 2005/0193934 A1
(43) Pub. Date: Sep. 8, 2005

(54) Planting guide

(76) Inventor: Laura Sullivan, Oak Brook, IL (US)

Correspondence Address: BARNES & THORNBURG, P.O. BOX 2786, CHICAGO, IL, 60690-2786, US

(21) Appl. No.: 11/056,994

(22) Filed: Feb. 11, 2005

Related U.S. Application Data
(60) Provisional application No. 60/546,115, filed on Feb. 19, 2004.

(51) Int. Cl. A01C 1/00

(52) U.S. Cl. 111/200

(57) ABSTRACT

An apparatus and method for arranging plants. The apparatus being a planting guide comprising a flat sheet; a plurality of markings arranged about a point on the sheet; and indicia corresponding and adjacent to each of the markings, indicating distance of the marking relative to the point on the sheet. The planting guide having a plurality of markings being set out with the markings facing up; a plurality of plants being placed on the planting guide within one of the markings; and the plants configured.

### RELATED APPLICATIONS

This application claims the benefit of U.S. Provisional Application No. 60/546,115, filed Feb. 19, 2004.

### BACKGROUND AND SUMMARY

Garden stores today typically offer a variety of plants of various shapes and sizes to consumers for planting in their homes or workplaces. These plants may be planted in outdoor gardens, but it is equally possible that one or more of the purchased plants will be arranged in a planter or other plant container. A problem faced by plant purchasers is determining how many plants will fit into a particular planter. The planter is often too heavy to be carried into the store. It would useful for the plant purchaser to have a portable guide or tool that allows the purchaser to figure out how many plants will fit into a particular planter.

A purchaser is also faced with the problem of designing a layout or configuration for the purchased plants. A good source of help in such designing is the garden store salespeople. It would be useful for the purchaser to have guide or tool that allows the purchaser to, onsite at the store, try out different configurations and placements of plants that the purchaser is considering buying so that input from the salespeople is possible.

Briefly, and in accordance with the foregoing, disclosed is an apparatus and method of using an apparatus, for selecting plants to fill a planter. The apparatus is a printed sheet having a shape corresponding to the shape of a particular container. The apparatus includes co-centric markings offset at increasing distances from the center, having a shape such as a circle, square, rectangle, polygon, or irregular shape that corresponds to the shape of the subject planter. For at least one of the markings, indicia showing a size dimension for that marking is printed adjacent thereto. Also disclosed in a method of using the apparatus, the method including the steps of iteratively arranging one or more plants within the area defined by the marking having the dimension corresponding to the desired planter until the area is filled and/or a desirable arrangement of plants is achieved.

Additional features will become apparent to those skilled in the art upon consideration of the following detailed description of drawings exemplifying the best mode as presently perceived.

### BRIEF DESCRIPTION OF THE DRAWINGS

The present disclosure will be described hereafter with reference to the attached drawings which are given as a non-limiting example only, in which:

FIG. 1 is a plan view of one surface of a planting guide for use with circular planters;

FIG. 2 is the other side of the planting guide of FIG. 1.

The exemplification set out herein illustrates embodiments of the disclosure that is not to be construed as limiting the scope of the disclosure in any manner.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

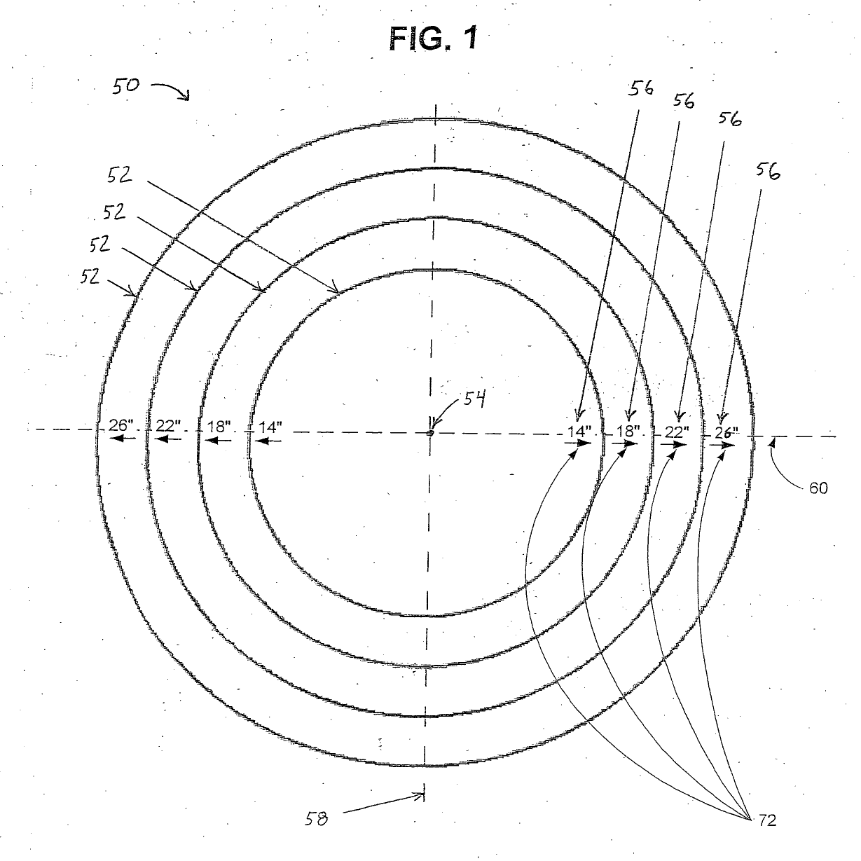

With reference to figures, FIG. 1 is a top view of one surface of a planting guide 50. Planting guide 50 includes two or more markings 52, that are offset by increasing distances from a center point 54. FIG. 1 shows a circular embodiment of markings 52. Although markings 52 are shown in this embodiment as having equal increments in the radius dimension between markings 52, it is contemplated that other non-equal increments may be used as well.

Planting guide 50 may be constructed or die cut from any flat, light weight material appropriate for printing indicia thereon, such a paper, card board, polystyrene, or other plastic. Optionally, planting guide 50 may be laminated with a protective material to prevent damage to the planting guide 50 in case of contact with liquid such as water, soil, dirt, or other materials commonly found in garden centers or in planting environments. Such lamination also allows easy cleaning of the planting guide after repeated use without risk of damaging or permanently obstructing the markings and indicia theron.

Planting guide 50 may also include measurement indicia 56 for identifying a dimension of a specific marking 52. For example, measurement indicia 56 may represent a diameter or radius of a particular circular marking 52. Measurement indicia 56 may be placed adjacent to the corresponding marking 52 for easy reference. Measurement indicia 56 may also be alternatively spaced along axes 58, 60 or in different quadrants to allow sufficient spacing between the measurement indicia 56 to allow for easy reading.

An alternative embodiment (not shown) of a planting guide 50 is suitable for use with a variety of sizes of square planters this embodiment of planting guide 50 uses square markings 52 having sides of equal length. Each marking 52 defines, as viewed from the center point moving outwardly, an increasing area. Although a uniform distance is shown between markings 52, marking of varying offset distance may be used as well. Although the markings 52 are shown in solid line, dashed or partial lines that demarcate an area of specified dimension may be used as well.

Another embodiment of the planting guide 50 is suitable for use with a variety of rectangular planters and has rectangular markings 52. A uniform distance may be used between markings as well as varying offset distance. Also, different values for the length to width ratio of the rectangular markings may be used and still be within the scope of this disclosure, allowing for rectangular containers of any shape to be used on the planting guide.

Although not illustrated, other embodiments of the planting guide may be constructed having markings corresponding to other shapes, including without limitation, triangles, polygons, and irregular shapes. Is also envisioned that a single planning guide may have a combination of differently shaped markings, such as combining two or more square markings with two or more circular markings, so that one planting guide can be used for both square and circular containers.

Markings, either in single-shape or combination-shape embodiments of the planting guide may also be in different colors for easier readings in case part or all of a line is obscured by the plant during use. Measurement indicia may be color coded to match their corresponding marking for easier reference.

With reference to FIG. 1, although the measurement indicia 52 correspond to a 14″ to 26″ diameter circles, incrementing in diameter by 2″ between each circular marking, the planting guide 50 may be scaled to other sizes and may use other units to show size, such as using centimeters in a metric embodiment. Other embodiments for differently shaped containers may likewise have varying scale or use other unit systems.

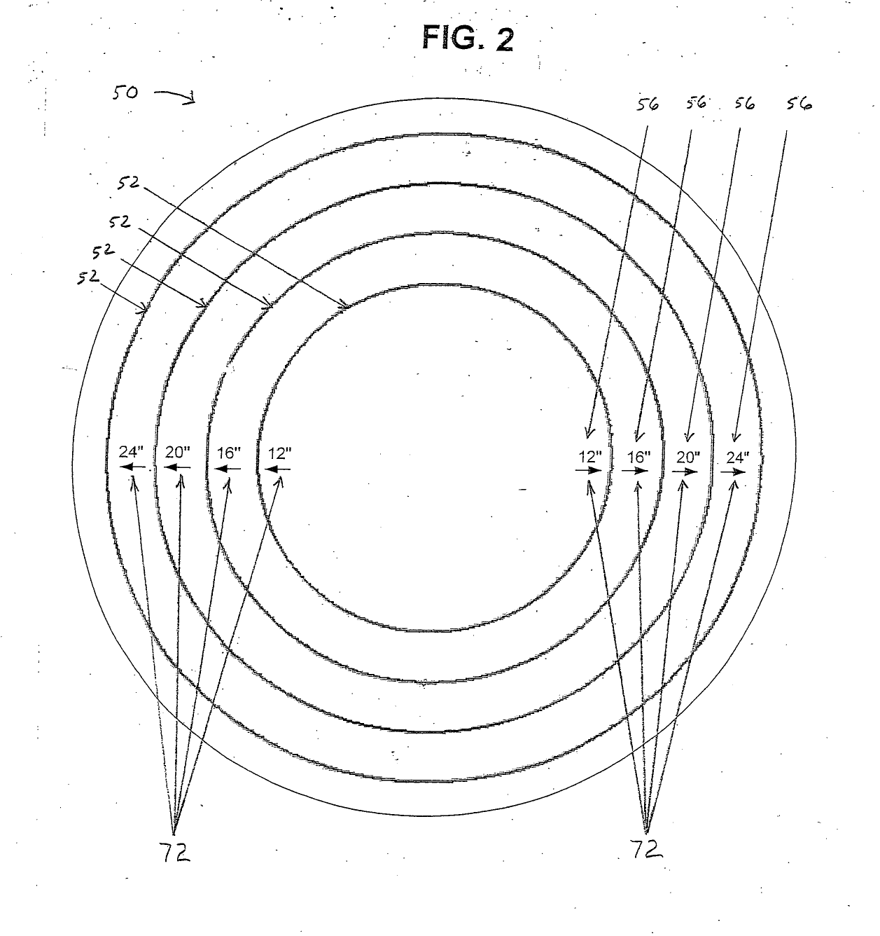

The planting guide may also be two sided having the same or different markings on opposing sides. A two-sided embodiment having the same shaped markings on each side may position less than all the markings and corresponding indicia on one side, and the remaining markings and corresponding indicia on the other side. For example, as shown in FIG. 1, one side may show markings and indicia corresponding to 14″, 18″, 22″, and 26″ circles, while the other side, as shown in FIG. 2, shows markings and indicia for 12″, 16″, 20″, and 24″ circles. Arrows 72 or other directional indicia may be used to show which marking corresponds to the printed dimension indicia.

The method of use of the planting guide is illustrated in the following example. A potential purchaser comes into a garden center. The purchaser needs plants to put in his or her container or planter that the purchaser does not have with them. The purchaser tells the garden center their container has a 12″ diameter opening. The garden center brings out the planting guide. The purchaser can then buy the number of plants that will fill the 12″ circle marking on the planting guide, which means the plants will fill the purchaser's 12″ container. Also, the purchaser can arrange, add, remove, rearrange, and otherwise configure plants for inclusion in the container, on location, and if desired, with the help of the garden center. It is useful, and fun, for purchasers to design their containers on-site. Also, the purchaser may own his or her own planting guide and use it at one or more of the plant purchasing locations he or she visits.

While several embodiments of the disclosure are shown and described, it is envisioned that those skilled in the art may devise various modifications and equivalents without departing from the spirit and scope of the disclosure. The present disclosure relates to one or more of the following features, elements, steps, or combinations thereof:

1. A planting guide comprising:
a flat sheet having a first side and a second side;
at least one marking on said first side; and
indicia corresponding and adjacent to said first marking.

2. The planting guide of claim 1 further comprising:
at least one marking on said second side of said sheet; and
indicia corresponding and adjacent to said second marking.

3. The planting guide of claim 1 further comprising:
a plurality of markings on said first side or on said second side, said markings being arranged about a point thereon;
a plurality of indicia, each indicia corresponding and adjacent to one of said markings.

4. The planting guide of claim 3 wherein said plurality of markings are arranged at increasing distances from said point.

5. The planting guide of claim 4 wherein said plurality of markings is comprised of a plurality of geometric figures arranged about said point.

6. The planting guide of claim 5 wherein said geometric figures are comprised of a plurality of concentric circles about said point.

7. The planting guide of claim 6 wherein said indicia indicate the length of the diameter of each of said concentric circles.

8. The planting guide of claim 5 wherein said geometric figures are comprised of a plurality of concentric rectangles about said point.

9. The planting guide of claim 5 wherein said indicia indicate the length of an axis of each of said plurality of geometric figures.

10. The planting guide of claim 3 wherein said sheet is laminated.

11. A planting guide comprising:
a flat sheet having a first side and a second side;
a plurality of concentric circles on said first side or on said second side, said concentric circles being arranged about a point thereon and at increasing distance therefrom;
a plurality of indicia, each of said plurality of indicia corresponding and adjacent to one of said plurality of concentric circles and indicating the diameter of said circle.

12. A method of using a planting guide comprising, in combination, the steps of:
setting out a planting guide having a plurality of markings with said markings facing up;
placing a plurality of plants on said planting guide within one of said plurality of markings; and
configuring said plurality of plants within said marking.
